(19) United States
(12) Patent Application Publication
(10) Pub. No.: US 2015/0184002 A1
(43) Pub. Date: Jul. 2, 2015

(54) Method For Producing A Multicoat Color And/Or Effect Paint System

(71) Applicant: BASF Coatings GmbH, Münster (DE)

(72) Inventors: Bernhard Steinmetz, Rutschenhausen (DE); Matthias Schad, Wurzburg (DE); Peggy Jankowski, Guntersleben (DE)

(21) Appl. No.: 14/420,067

(22) PCT Filed: Aug. 5, 2013
(86) PCT No.: PCT/EP2013/066400

§ 371 Date: Feb. 6, 2015

Related U.S. Application Data
(60) Provisional application No. 61/680,282, filed on Aug. 7, 2012.

(30) Foreign Application Priority Data
Aug. 7, 2012 (EP) 12179470.5

(51) Int. Cl. C09D 7/12

(52) U.S. Cl. CPC C09D 7/1233

(57) ABSTRACT

Described is a method for producing a multicoat color and/or effect paint system, the method comprising: (1) applying a pigmented aqueous basecoat material to a substrate, (2) forming a polymer film from the basecoat material applied in stage (1), (3) applying a clearcoat material to the resulting polymer film, and subsequently (4) curing the polymer film together with the clearcoat film. In stage (1) a pigmented aqueous basecoat material is used that comprises at least one ether compound of the structural formula (I)

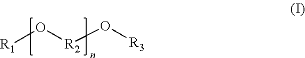

wherein R₁ is a Cₓ alkyl radical, R₂ is a C_{y} alkylene radical and R₃ is a C_{z} alkyl radical, n is 0 to 5, and wherein x+n·y+z=18 to 24. Also described are coating materials and also the use of the ether compounds in pigmented aqueous coating materials.

### CROSS-REFERENCE TO RELATED APPLICATIONS

This is application is the National Stage Entry of PCT/EP2013/066400, filed Aug. 5, 2013, which claims priority to U.S. Provisional Application Ser. No. 61/680,282, filed Aug. 7, 2012, and European Patent Application 12179470.5, filed Aug. 7, 2012, the disclosures of which are incorporate herein by reference in their entireties.

### TECHNICAL FIELD

The invention relates to a method for producing a multicoat color and/or effect paint system by
(1) applying a pigmented aqueous basecoat material to a substrate,
(2) forming a polymer film from the basecoat material applied in stage (1),
(3) applying a clearcoat material to the resulting basecoat polymer film, and subsequently
(4) curing the basecoat polymer film together with the clearcoat film.

The invention relates, furthermore, to pigmented aqueous basecoat materials which are suitable for producing multicoat color and/or effect paint systems.

### BACKGROUND

The method described above is known (cf., for example, German patent application DE 199 48 004 A1, page 17, line 37, to page 19, line 22, or German patent DE 100 43 405 C1, column 3, paragraph [0018], and column 8, paragraph [0052], to column 9, paragraph [0057], in conjunction with column 6, paragraph [0039], to column 8, paragraph [0050]) and is extensively used, for example, both for the OEM finishing and for refinish of automobile bodies.

The basecoat/clearcoat method, as it is known, in question is used in conjunction with wet-on-wet techniques to give multicoat color and/or effect paint systems. With these systems, visible pinholes frequently occur, as extremely small holes in the clearcoat and basecoat films.

### SUMMARY

Provided, therefore, is a method of the above-described kind with which multicoat color and/or effect paint systems are obtainable that are improved in relation to the prior-art paint systems. The paint systems, more particularly, o exhibit no pinholes, or only very few, and/or exhibit a raised pinholing limit. The pinholing limit is the dry basecoat film thickness above which pinholes occur.

### DETAILED DESCRIPTION

In one or more embodiments, in stage (1) of the above-described basecoat/clearcoat method a pigmented aqueous basecoat material is used, which comprises at least one ether compound of the structural formula (I)

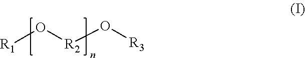

where R₁ is a Cₓ alkyl radical, R₂ is a C_{y} alkylene radical and R₃ is a C_{z} alkyl radical, n is 0 to 5, the further condition x+n·y+z=18 to 24 is met, and the sum total of the weight percentage fractions, based on the total weight of the aqueous basecoat material applied in stage (1), of all of the ether compounds of structural formula (I) is 0.1% to 5% by weight.

In one or more embodiments, the pigmented aqueous coating materials, which are described above, can be used in stage (1) of the basecoat/clearcoat method.

In stage (1) of the method, it is possible in principle to use all known aqueous basecoat materials when they comprise at least one ether compound of the invention and when the sum total of the weight percentage fractions, based on the total weight of the aqueous basecoat material applied in stage (1), of all of the ether compounds of the structural formula (I) is 0.1% to 5% by weight.

Basecoat materials are termed “aqueous” when they contain 30% to 70% by weight of water, based on the total weight of the basecoat material. The terms “aqueous basecoat material” and “waterborne basecoat material” are used in this application as synonymous terms.

The basecoat materials used in accordance with the invention comprise color and/or effect pigments Such color pigments and effect pigments are known to the skilled person and described for example in Römpp-Lexikon Lacke and Druckfarben, Georg Thieme Verlag, Stuttgart, N.Y., 1998, pages 176 and 451. The fraction of the pigments may be situated for example in the range from 1% to 40% by weight, specifically 2% to 20% by weight, more specifically 5% to 15% by weight, based on the total weight of the pigmented aqueous basecoat material.

The method of the invention prefers use of basecoat materials comprising as their binders binders curable physically, thermally, or thermally and with actinic radiation.

With particular preference at least one saturated or unsaturated polyurethane resin binder is present. Coating materials of this kind, comprising polyurethane resin, may likewise typically be cured physically, thermally, or thermally and with actinic radiation.

In the context of the present invention, the term “physical curing” denotes the formation of a film by loss of solvent from polymer solutions or polymer dispersions. Normally no crosslinking agents are needed for such curing.

In the context of the present invention, the term “thermal curing” denotes the heat-initiated crosslinking of a coating film where in the parent coating material either a separate crosslinking agent or else self-crosslinking binders are employed. The crosslinking agent comprises reactive functional groups which are complementary to the reactive functional groups present in the binders. This is typically referred to by those in the art as external crosslinking. Where the complementary reactive functional groups or autoreactive functional groups, i.e., groups which react with groups of the same kind, are already present in the binder molecules, the binders are self-crosslinking. Examples of suitable complementary reactive functional groups and autoreactive functional groups are known from German patent application DE 199 30 665 A1, page 7, line 28 to page 9, line 24.

In the context of the present invention, actinic radiation means electromagnetic radiation such as near infrared (NIR), UV radiation, more particularly UV radiation, and particulate radiation such as electron radiation. Curing by UV radiation is typically initiated by radical or cationic photoinitiators.

Where thermal curing and curing with actinic light are employed jointly, the term “dual cure” is also used.

In the present invention, preferred basecoat materials are those which are curable thermally or both thermally and with actinic radiation, in other words by “dual cure”. Particularly preferred basecoat materials are those which comprise a polyurethane resin binder and as crosslinking agent an amino resin or a blocked or nonblocked polyisocyanate, specifically an amino resin. Among the amino resins, melamine resins are preferred more particularly.

The polyurethane resin specifically present may be ionically and/or nonionically hydrophilically stabilized. In preferred embodiments of the present invention, the polyurethane resin is ionically hydrophilically stabilized. The preferred polyurethane resins are linear or contain branches. Particular preference is given to a polyurethane resin connected with olefinically unsaturated monomers. Olefinically unsaturated monomers attached to the polyurethane resin (A) are specifically monomers containing acrylate groups and/or methacrylate groups, producing polyurethane(meth)acrylates. With very particular preference the polyurethane resin is a polyurethane(meth)acrylate. The polyurethane resin specifically present is curable physically, thermally, or thermally and with actinic radiation. More particularly it is curable thermally or both thermally and with actinic radiation. With particular preference the polyurethane resin comprises reactive functional groups through which external crosslinking is possible.

The term “(meth)acrylate” is intended below to refer both to acrylate and to methacrylate. In other words, therefore, a corresponding polymer may be composed both of acrylates or methacrylates, and also, optionally, may include further ethylenically unsaturated monomers different from (meth)acrylates.

Suitable saturated or unsaturated polyurethane resins are described for example in
German patent application DE 199 14 896 A1, column 1, lines 29 to 49 and column 4, line 23 to column 11, line 5;
German patent application DE 199 48 004 A1, page 4, line 19 to page 13, line 48;
European patent application EP 0 228 003 A1, page 3, line 24 to page 5, line 40;
European patent application EP 0 634 431 A1, page 3, line 38 to page 8, line 9; or
international patent application WO 92/15405, page 2, line 35 to page 10, line 32.

For the preparation of the polyurethane resin it is preferred to make use of the aliphatic, cycloaliphatic, aliphatic-cycloaliphatic, aromatic, aliphatic-aromatic and/or cycloaliphatic-aromatic polyisocyanates known to the skilled person.

As an alcohol component for preparing the polyurethane resins it is preferred to use the saturated or unsaturated, relatively high molecular mass and low molecular mass, polyols and also, optionally, monoalcohols in minor amounts, that are known to the skilled person. Low molecular mass polyols used are more particularly diols and optionally, in minor amounts, triols for the purpose of introducing branches. Examples of suitable polyols of relatively high molecular mass are saturated or olefinically unsaturated polyester polyols and/or polyether polyols. Relatively high molecular mass polyols used more particularly are polyester polyols, especially those having a number-average molecular weight of 400 to 5000 g/mol (measured by gel permeation chromatography against a polystyrene standard, with tetrahydrofuran as eluent).

For the hydrophilic stabilization and/or for increasing the dispersibility in aqueous media, the polyurethane resin specifically present may comprise particular ionic groups and/or groups which can be converted into ionic groups (potentially ionic groups). Such polyurethane resins are referred to in the context of the present invention as ionically hydrophilically stabilized polyurethane resins. Likewise present may be nonionic hydrophilically modifying groups. Preference is given, however, to the ionically hydrophilically stabilized polyurethanes. More specifically the modifying groups are
functional groups which can be converted into cations by neutralizing agents and/or quaternizing agents and/or cationic groups (cationic modification)
   or
functional groups which can be converted into anions by neutralizing agents, and/or anionic groups (anionic modification)
   and/or
nonionic hydrophilic groups (nonionic modification).

As the skilled person is aware, the functional groups for cationic modification are, for example, primary, secondary and/or tertiary amino groups, secondary sulfide groups and/or tertiary phosphine groups, more particularly tertiary amino groups and secondary sulfide groups (functional groups which can be converted into cationic groups by neutralizing agents and/or quaternizing agents). Also noteworthy are the cationic groups prepared from the aforementioned functional groups using neutralizing agents and/or quaternizing agents known to the skilled person, such as primary, secondary, tertiary and/or quaternary ammonium groups, tertiary sulfonium groups and/or quaternary phosphonium groups, more particularly quaternary ammonium groups and tertiary sulfonium groups.

The functional groups for anionic modification are as is known, for example, carboxylic, sulfonic and/or phosphonic acid groups, more particularly carboxylic acid groups (functional groups which can be converted into anionic groups by neutralizing agents), and also anionic groups prepared from the aforementioned functional groups using neutralizing agent known to the skilled person, such as carboxylate, sulfonate and/or phosphonate groups.

The functional groups for nonionic hydrophilic modification are specifically poly(oxyalkylene) groups, more particularly poly(oxyethylene) groups.

The ionically hydrophilic modifications may be introduced into the polyurethane resin by monomers which comprise the (potentially) ionic groups. The nonionic modifications are introduced, for example, through the incorporation of poly(ethylene) oxide polymers as side groups or terminal groups of the polyurethane molecules. The hydrophilic modifications are introduced, for example, via compounds which comprise at least one group that is reactive toward isocyanate groups, specifically at least one hydroxyl group. For introducing the ionic modification it is possible to use monomers which as well as the modifying groups comprise at least one hydroxyl group. For introducing the nonionic modifications it is preferred to use the alkoxypoly(oxyalkylene) alcohols and/or polyetherdiols that are known to the skilled person.

The polyurethane resin may specifically be a graft polymer. More particularly it is a polyurethane resin grafted using olefinically unsaturated compounds, specifically olefinically unsaturated monomers. In this case, therefore, the polyurethane is grafted, for example, with side groups and/or side chains that are based on olefinically unsaturated monomers. The groups or chains in question are more particularly side chains based on poly(meth)acrylates. Poly(meth)acrylates in the context of the present invention are polymers or polymeric radicals which comprise monomers containing acrylate and/or methacrylate groups, and specifically consist of monomers containing acrylate and/or methacrylate groups. Side chains based on poly(meth)acrylates are side chains which are constructed during graft polymerization using monomers containing (meth)acrylate groups. In this case, during the graft polymerization, specifically more than 50 mol %, more particularly more than 75 mol %, more particularly 100 mol % of monomers containing (meth)acrylate groups are used, based on the total amount of the monomers used in the graft polymerization.

The side chains described are introduced into the polymer specifically after the preparation of a primary polyurethane resin dispersion. In this case the polyurethane resin present in the primary dispersion may comprise pendant and/or terminal olefinically unsaturated groups, via which the graft polymerization with the olefinically unsaturated compounds then proceeds. The polyurethane resin for grafting may therefore be an unsaturated polyurethane resin (A). The graft polymerization is in that case a radical polymerization of olefinically unsaturated reactants. Also possible, for example, is for the olefinically unsaturated compounds used for the graft polymerization to comprise at least one hydroxyl group. In that case it is also possible initially for there to be attachment of the olefinically unsaturated compounds via these hydroxyl groups, by reaction with free isocyanate groups of the polyurethane resin. This attachment occurs instead of or in addition to the radical reaction of the olefinically unsaturated compounds with any pendant and/or terminal olefinically unsaturated groups that may be present in the polyurethane resin. This is then followed, again, by the graft polymerization via radical polymerization as described earlier on above. In each case, polyurethane resins are obtained that are grafted with olefinically unsaturated compounds, specifically olefinic ally unsaturated monomers.

As olefinically unsaturated compounds with which the polyurethane resin (A) is specifically grafted it is possible to use virtually all radically polymerizable, olefinically unsaturated and organic monomers that are available to the skilled person for these purposes. A number of preferred monomer classes may be cited as examples:
hydroxyalkyl esters of (meth)acrylic acid or of other alpha, beta-ethylenically unsaturated carboxylic acids,
(meth)acrylic acid alkyl esters and/or cycloalkyl esters having up to 20 carbon atoms in the alkyl radical,
ethylenically unsaturated monomers, comprising at least one acid group, more particularly precisely one carboxyl group, such as (meth)acrylic acid,
vinyl esters of monocarboxylic acids branched in alpha position and having 5 to 18 carbon atoms,
reaction products of (meth)acrylic acid with the glycidyl ester of a monocarboxylic acid branched in alpha position and having 5 to 18 carbon atoms,
other ethylenically unsaturated monomers such as olefins (for example ethylene), (meth)acrylamides, vinylaromatic hydrocarbons (styrene for example), and vinyl compounds such as vinyl chloride and/or vinyl ethers such as ethyl vinyl ethers.

Preference is given to using monomers containing (meth)acrylate groups, and so the grafted-on side chains are poly(meth)acrylate-based side chains.

The pendant and/or terminal olefinically unsaturated groups in the polyurethane resin, via which graft polymerization with the olefinically unsaturated compounds is able to proceed, are introduced into the polyurethane resin specifically by way of monomers which as well as an olefinically unsaturated group also comprise, for example, at least one group reactive toward isocyanate groups. Hydroxyl groups and also primary and secondary amino groups are preferred. Hydroxyl groups are especially preferred.

Of course, the monomers described by which the pendant and/or terminal olefinically unsaturated groups may be introduced into the polyurethane resin may also be employed without the polyurethane resin being additionally grafted thereafter with olefinically unsaturated compounds. It is preferred, however, for the polyurethane resin to be grafted with olefinically unsaturated compounds.

The polyurethane resin specifically present may be a self-crosslinking and/or externally crosslinking binder. The polyurethane resin specifically comprises reactive functional groups through which external crosslinking is possible. In this case, the pigmented aqueous basecoat material specifically comprises at least one crosslinking agent. More particularly, the reactive functional groups through which external crosslinking is possible are hydroxyl groups. For the purposes of the method of the invention it is possible with particular advantage to use polyhydroxy-functional polyurethane resins. This means that the polyurethane resin contains on average more than one hydroxyl group per molecule.

The polyurethane resin is prepared by the typical methods of polymer chemistry. This means, for example, the polymerization of polyisocyanates and polyols to polyurethanes, and the graft polymerization that specifically then follows with olefinically unsaturated compounds. These techniques are known to the skilled person and may be adapted individually. Exemplary preparation processes and reaction conditions are found in European patent EP 0 521 928 B1, page 2, line 57 to page 8, line 16.

If the basecoat materials specifically used are self-crosslinking systems, the amount of polyurethane resin is 50% to 100% by weight, specifically 50% to 90% by weight, and more specifically 50% to 80% by weight, based on the film-forming solids of the basecoat material. In other words, where polyurethane resins are used which realize the preferred features described above, the amount of these polyurethane resins is 50% to 100%, specifically 50% to 90%, and more specifically 50% to 80%, by weight, based on the film-forming solids of the basecoat material. It is further preferred here for the basecoat material used to comprise exclusively those polyurethane resins which do realize the preferred features described above.

By film-forming solids is meant the nonvolatile weight fraction of the basecoat material, excluding pigments and any fillers. The film-forming solids can be determined as follows: A sample of the pigmented aqueous basecoat material (approximately 1 g) is admixed with 50 to 100 times the amount of tetrahydrofuran and then stirred for about 10 minutes. The insoluble pigments and any fillers are then removed by filtration, and the residue is rinsed with a little THF, after which the THF is removed from the resultant filtrate on a rotary evaporator. The filtrate residue is dried at 120° C. for two hours and the film-forming solids that results in this drying operation is weighed.

In the case of externally crosslinking systems, the polyurethane resin content is 10% to 80%, specifically 15% to 75%, and more specifically 20 to 70%, by weight, based in each case on the film-forming solids of the basecoat material. Where polyurethane resins are used which realize the preferred features described above, the amount of these polyurethane resins is 10% to 80%, specifically 15% to 75%, and more specifically 20% to 70%, by weight, based on the film-forming solids of the basecoat material. It is further preferred here for the basecoat material employed to comprise exclusively those polyurethane resins which do realize the preferred features described above.

The polyurethane resin specifically present possesses specifically a number-average molecular weight of 200 to 30 000 g/mol, specifically of 2000 to 20 000 g/mol (measured by means of gel permeation chromatography against a polystyrene standard; tetrahydrofuran is employed as eluent). It additionally possesses, for example, a hydroxyl number of 0 to 250 mg KOH/g, but more particularly of 20 to 150 mg KOH/g. The acid number of the polyurethane resin is specifically 5 to 200 mg KOH/g, more particularly 10 to 40 mg KOH/g. The hydroxyl number is determined in accordance with DIN/ISO 4629, the acid number in accordance with DIN 53402.

It is essential to the invention that the aqueous basecoat materials used in stage (1) of the method of the invention comprise at least one ether compound of the structural formula (I):

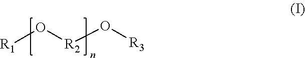

where R₁ is a Cₓ alkyl radical, R₂ is a C_{y} alkylene radical and R₃ is a C_{z} alkyl radical, n is 0 to 5, the further condition x+n·y+z=18 to 24 is met, and the sum total of the weight percentage fractions, based on the total weight of the aqueous basecoat material applied in stage (1), of all of the ether compounds of structural formula (I) is 0.1% to 5% by weight.

The sum total of the weight percentage fractions, based on the total weight of the aqueous basecoat material applied in stage (1), of all of the ether compounds of structural formula (I) is specifically 0.1% to 4.5% by weight and very specifically 0.2% to 4% by weight.

If the amount of the at least one ether compound of the invention is below 0.1% by weight, the problem addressed by the invention is not solved. Where the amount is more than 5% by weight, disadvantages occur, such as a deterioration in adhesion in the case of underbaked systems, for example.

Specifically, moreover, x+n·y+z is 18 to 22. Likewise specifically, n is 0 to 3, more specifically n is 0 to 2, and very specifically n is 0. The sum total of the weight percentage fractions, based on the total weight of the aqueous basecoat material applied in stage (1), of all of the ether compounds of structural formula (I) which realize the preferred feature of x+n·y+z being 18 to 22 and/or the feature with respect to n that is identified above as preferred, more preferred, and very preferred, respectively, is likewise 0.1% to 5% by weight, specifically 0.1% to 4.5% by weight, and very specifically 0.2% to 4% by weight. It is further preferred here for the said basecoat material to comprise exclusively ether compounds of the invention that realize the preferred feature of x+n·y+z being 18 to 22 and/or the feature in respect of n identified above as being preferred, more preferred, and very preferred, respectively.

It is preferred to use a mixture of the ether compounds of the invention where n is 0 to 2 and additionally the condition x+n·y+z=18 to 22 is met. Preference is likewise given to using a mixture of the ether compounds of the invention where n is 0 and additionally the condition x+n·y+z=18 to 22 is met. The sum total of the weight percentage fractions, based on the total weight of the aqueous basecoat material applied in stage (1), of the ether compounds of the invention in the mixtures referred to above is likewise 0.1% to 5% by weight, specifically 0.1% to 4.5% by weight, and very specifically 0.2% to 4% by weight. It is further preferred here for said basecoat material to comprise exclusively the ether compounds of the invention that are specified in this paragraph.

It is preferred to use a mixture of the ether compound of the invention. A mixture of the ether compound of the invention is available under the brand name Vammar® D10, for example.

Specifically, moreover, a thickener is present. Suitable thickeners are inorganic thickeners from the group of the phyllosilicates. Besides the inorganic thickeners, however, it is also possible to use one or more organic thickeners. These organic thickeners are specifically selected from the group consisting of (meth)acrylic acid-(meth)acrylate copolymer thickeners, such as, for example, the commercial product Viscalex HV30 (Ciba, BASF), and polyurethane thickeners, such as, for example, the commercial product DSX® 1550 from Cognis. (Meth)acrylic acid-(meth)acrylate copolymer thickeners are those which as well as acrylic acid and/or methacrylic acid also include in copolymerized form one or more acrylic esters (in other words acrylates) and/or one or more methacrylic esters (in other words methacrylates). A feature common to the (meth)acrylic acid-(meth)acrylate copolymer thickeners is that in an alkaline medium, in other words at pH levels >7, more particularly >7.5, they exhibit a sharp increase in viscosity as a result of salt formation by the acrylic acid and/or methacrylic acid, in other words as a result of the formation of carboxylate groups. Where (meth)acrylic esters are used that are formed from (meth)acrylic acid and a C₁-C₆ alkanol, the products are essentially nonassociative (meth)acrylic acid-(meth)acrylate copolymer thickeners, such as the aforementioned Viscalex HV30, for example. Substantially nonassociative (meth)acrylic acid-(meth)acrylate copolymer thickeners are also referred to in the literature as ASE thickeners (“alkali soluble/swellable emulsion” or dispersion). As (meth)acrylic acid-(meth)acrylate copolymer thickeners it is also possible, however, to use what are called HASE thickeners (“hydrophobically modified anionic soluble emulsions” or dispersions). These are obtained if the alkanol used, instead of or in addition to the C₁-C₆ alkanols, comprises alkanols having a greater number of carbon atoms, such as 7 to 30, for example, or 8 to 20 carbon atoms. HASE thickeners are substantially associative in their thickening effect. On account of their thickening properties, the (meth)acrylic acid-(meth)acrylate copolymer thickeners that can be used are not suitable as binder resins, and are therefore not included in the binders that are curable physically, thermally or both thermally and actinically and are identified as binders, and they are therefore explicitly different from the poly(meth)acrylate-based binders which can be used in the basecoat compositions of the invention. Polyurethane thickeners are the associative thickeners that are referred to in the literature as HEUR (“hydrophobically modified ethylene oxide urethane rheology modifiers”). In chemical terms they are nonionic branched or nonbranched block copolymers of polyethylene oxide chains (sometimes also polypropylene oxide chains) which are linked to one another via urethane bonds and which carry terminal long-chain alkyl or alkylene groups having 8 to 30 carbon atoms. Typical alkyl groups are, for example, dodecyl or stearyl groups; a typical alkenyl group is, for example, an oleyl group; a typical aryl group is the phenyl group; and a typical alkylated aryl group is, for example, a nonylphenyl group. The polyurethane thickeners, on account of their thickening properties and structure, are not suitable as binder resins curable physically, thermally or both thermally and physically. They are therefore explicitly different from the polyurethanes which can be used as binders in the basecoat compositions of the invention.

The pigmented aqueous basecoat material to be used specifically further comprises at least one polyester, more particularly a polyester having a number-average molecular weight of 400 to 5000 g/mol (measured by means of gel permeation chromatography against a polystyrene standard; tetrahydrofuran is used as eluate). Corresponding polyesters are described in DE 4009858 in column 6, line 53 to column 7, line 61 and column 10, line 24 to column 13, line 3.

The pigmented aqueous basecoat material may also, furthermore, comprise at least one additive. Examples of such additives are salts which can be decomposed thermally without residue or substantially without residue, resins which are curable physically, thermally and/or with actinic radiation and are different from polyurethane resins, as binders, further crosslinking agents, organic solvents, reactive diluents, transparent pigments, fillers, molecularly dispersely soluble dyes, nanoparticles, light stabilizers, antioxidants, deaerating agents, emulsifiers, slip additives, polymerization inhibitors, free radical polymerization initiators, adhesion promoters, flow control agents, film-forming assistants, sag control agents (SCAs), flame retardants, corrosion inhibitors, waxes, siccatives, biocides, and matting agents.

Suitable additives of the aforementioned kind are known for example from
German patent application DE 199 48 004 A1, page 14, line 4, to page 17, line 5,
German patent DE 100 43 405 C1, column 5, paragraphs [0031] to [0033].

They are used in the customary and known amounts.

The solids content of the basecoat materials used in accordance with the invention may vary according to the requirements of the individual case. First and foremost the solids content is guided by the viscosity that is required for application, more particularly spray application, and so it may be set by the skilled person on the basis of his or her general art knowledge, with the assistance where appropriate of a few rangefinding tests.

The solids content of the basecoat materials is specifically 5% to 70%, more specifically 10% to 65%, and with particular preference 15% to 60%, by weight.

By solids content is meant that weight fraction which remains as a residue on evaporation under defined conditions. In the present specification, the solids has been determined in accordance with DIN EN ISO 3251. The measuring time was 60 minutes at 125° C.

The basecoat materials used in accordance with the invention can be prepared using the mixing methods and mixing assemblies that are customary and known for producing basecoat materials.

The basecoat materials of the invention may be employed as one-component (1K), two-component (2K) or multicomponent (3K, 4K) systems. Preference is given to 1K systems.

In one-component (1K) systems, binder and crosslinking agent are present alongside one another, i.e., in one component. A prerequisite for this is that the two constituents crosslink with one another only at relatively high temperatures and/or on exposure to actinic radiation.

In two-component (2K) systems, for example, binder and crosslinking agent are present separately from one another in at least two components, which are not combined until shortly before application. This form is selected when binder and crosslinking agent react with one another even at room temperature. Coating materials of this kind are employed in particular for coating thermally sensitive substrates, especially in automotive refinish.

The application of the pigmented aqueous basecoat material used in accordance with the invention to a substrate may take place in the film thicknesses that are customary in the context of the automobile industry, in the range from, for example, 5 to 100 micrometers, specifically 5 to 60 micrometers. This is done by employing, for example, the known techniques such as spraying, knife coating, brushing, pouring, dipping, impregnating, trickling or rolling. Preference is given to employing spray application methods, such as, for example, compressed air spraying, airless spraying, high speed rotation, or electrostatic spray application (ESTA), alone or in conjunction with hot spray application such as hot air spraying, for example.

After the pigmented aqueous basecoat material has been applied, it may be dried by known techniques. For example, 1K basecoat materials may be flashed at room temperature for 1 to 60 minutes and subsequently dried specifically at optionally slightly elevated temperatures of 30 to 80° C. Flashing and drying for the purposes of the present invention mean the evaporation of organic solvents and/or water, whereby the coating material becomes drier, but is not yet cured, or there is as yet no formation of a fully crosslinked coating film.

A commercially customary clearcoat material is then applied likewise by common techniques, the film thicknesses again being situated within the customary ranges, such as 5 to 100 micrometers, for example. Clearcoat materials of this kind are known to the skilled person.

Following the application of the clearcoat material, it may be flashed at room temperature for 1 to 60 minutes, for example, and optionally dried. The clearcoat material is then cured together with the pigmented basecoat material applied. Here, for example, crosslinking reactions take place, to produce a multicoat color and/or effect paint system of the invention on a substrate. Curing takes place specifically thermally or both thermally and with actinic radiation, at temperatures from 80 to 200° C.

With the aid of the method of the invention it is possible to coat metallic and nonmetallic substrates, especially plastics substrates, specifically automobile bodies or parts thereof.

The invention also provides the corresponding coating materials and the use of the at least one ether compound of the invention that is employed in the basecoat materials of the invention for the purpose of raising the pinholing limit and/or for the purpose of reducing the number of pinholes in aqueous pigmented coatings. All features identified above in relation to the method of the invention likewise relate to the corresponding coating materials and to the use of the at least one ether compound of the invention that is employed in the basecoat materials of the invention for the purpose of raising the pinholing limit and/or for the purpose of reducing the number of pinholes in aqueous pigmented coatings. This applies also, in particular, to all specified preferred, more preferred, and very preferred features.

The invention is elucidated below with reference to examples.

### EXAMPLES

### 1. Preparation of a Silver Waterborne Basecoat Material 1

The components listed in Table A under “aqueous phase” are stirred together in the order stated to form an aqueous mixture. In the next step, an organic mixture is prepared from the components listed under “organic phase”. The organic mixture is added to the aqueous mixture. The resulting mixture is then stirred for 10 minutes and adjusted using deionized water and dimethanolamine to a pH of 8 and a spray viscosity of 58 mPas under a shearing load of 1000/sec, measured using a rotational viscometer (Rheomat RM 180 instrument from Mettler-Toledo) at 23° C.

TABLE A

| Component | Parts by weight |
|---|---|
| Aqueous phase | |
| 3% strength Na Mg phyllosilicate solution | 26 |
| Deionized water | 3 |
| Butyl glycol | 1.75 |
| Polyurethane acrylate; prepared as per page 7, line 55-page 8, line 23 of | 4.5 |
| DE-A-4437535 | |
| 50% strength by weight solution of DSX 1550 (Cognis) rheological | 0.6 |
| agent | |
| Polyester; prepared as per example D, column 16, lines 37-59 of DE-A- | 3.2 |
| 4009858 | |
| Tensid S (BASF); surfactant | 0.3 |
| Butyl glycol | 0.55 |
| Cymel 203; melamine-formaldehyde resin, available from Cytec | 4.1 |
| 10% strength dimethylethanolamine in water | 0.3 |
| Deionized water | 6 |
| Polyurethane acrylate; prepared as per page 19, line 44-page 20, line 21 | 20.4 |
| of DE-A-19948004 | |
| Surfynol ® 104 surfactant from Air Products (52% form) | 1.6 |
| Butyl glycol | 0.5 |
| 3% strength by weight aqueous solution of Viscalex HV 30; | 3.9 |
| rheological agent, available from BASF, in water | |
| Organic phase | |
| Mixture of two commercial aluminum pigments, available from Altana- | 6.2 |
| Eckart | |
| Butyl glycol | 7.5 |
| Polyester; prepared as per example D, column 16, lines 37-59 of DE-A- | 5 |
| 4009858 | |

### Waterborne Basecoat Material I1:

To prepare the inventive waterborne basecoat material I1, the waterborne basecoat material 1 was admixed with 1.5 parts by weight of the commercial product Vammar® D10.

TABLE 1
Compositions of the waterborne basecoat materials 1 and I1

| WBL | [% by weight] | Inventive ether compound |
|---|---|---|
| 1 | — | — |
| I1 | 1.5 | Vammar ® D10 |

The weight percentages in Table 1 relate to the fraction of the mixture of the inventive ether compound in the respective waterborne basecoat material.

### Comparative Experiment Between Waterborne Basecoat Material 1 and Waterborne Basecoat Material I1

For the determination of the pinholing limit and of the number of pinholes, the multicoat paint systems were produced in accordance with the following general instructions:

A steel panel with dimensions of 30×50 cm, coated with a primer-surfacer coat, was given an adhesive strip on one longitudinal edge in order to enable the differences in film thickness to be determined after coating. The waterborne basecoat material was applied electrostatically in wedge format. The resulting waterborne basecoat film was flashed for one minute at room temperature and then dried for 10 minutes in a forced air oven at 70° C. A customary two-component clearcoat material was applied to the dried waterborne basecoat film. The resulting clearcoat film was flashed at room temperature for 20 minutes. The waterborne basecoat film and the clearcoat film were then cured in a forced air oven at 140° C. for 20 minutes. Following visual evaluation of the pinholes in the resulting wedge-shaped multilayer paint system, the film thickness of the pinholing limit was ascertained. The results are found in Table 2.

TABLE 2
Pinholing limit and number of pinholes for waterborne basecoat material
1 and waterborne basecoat material I1

| | Pinholing limit | |
|---|---|---|
| WBL | (micrometers) | Number of pinholes |
| 1 | 20 | 17 |
| I1 | 30 | 1 |

The results emphasize the fact that the use of the mixture of the ether compound of the invention increases the pinholing limit in comparison to waterborne basecoat material 1, and at the same time reduces the number of pinholes.

1. A method for producing a multicoat color and/or effect paint system, the method comprising:
(1) applying a pigmented aqueous basecoat material to a substrate,
(2) forming a polymer film from the basecoat material applied in stage (1),
(3) applying a clearcoat material to the resulting polymer film, and subsequently
(4) curing the polymer film together with the clearcoat film,
wherein, in stage (1), a pigmented aqueous basecoat material is used which comprises at least one ether compound of the structural formula (I) 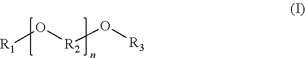
wherein R₁ is a Cₓ alkyl radical, R₂ is a C_{y} alkylene radical and R₃ is a C_{z} alkyl radical, n is 0 to 5, wherein −x+n·y+z=18 to 24, and the sum total of the weight percentage fractions, based on the total weight of the aqueous basecoat material applied in stage (1), of all of the ether compounds of structural formula (I) is 0.1% to 5% by weight.

2. The method of claim 1, wherein the sum total of the weight percentage fractions, based on the total weight of the aqueous basecoat material applied in stage (1), of all of the ether compounds of structural formula (I) is 0.2% to 4% by weight.

3. The method of claim 1, wherein a mixture of the said ether compounds is used.

4. The method of claim 1, wherein x+n·y+z=18 to 22.

5. The method of claim 1, wherein n is 0 to 2.

6. The method of claim 1, wherein n is 0 and wherein x+n·y+z=18 to 22.

7. A pigmented aqueous basecoat material comprising at least one ether compound of the structural formula (I) 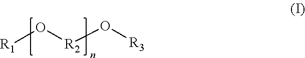
wherein R₁ is a Cₓ alkyl radical, R₂ is a C_{y} alkylene radical and R₃ is a C_{z} alkyl radical, n is 0 to 5 and wherein x+n·y+z=18 to 24, and the sum total of the weight percentage fractions, based on the total weight of the aqueous basecoat material, of all of the ether compounds of structural formula (I) is 0.1% to 5% by weight.

8. The pigmented aqueous basecoat material of claim 7, wherein the sum total of the weight percentage fractions, based on the total weight of the pigmented aqueous basecoat material, of all of the ether compounds of structural formula (I) is 0.2% to 4% by weight.

9. The pigmented aqueous basecoat material of claim 7, wherein a mixture of the said ether compounds is used.

10. The pigmented aqueous basecoat material of claim 7, wherein x+n·y+z=18 to 22.

11. The pigmented aqueous basecoat material of claim 7, wherein n is 0 and wherein x+n·y+z=18 to 22.

12. A method of reducing the number of pinholes in pigment basecoat materials, the method comprising adding at least one ether compound of the structural formula (I) 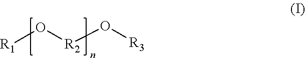
to a pigmented aqueous basecoat material, wherein R₁ is a Cₓ alkyl radical, R₂ is a C_{y} alkylene radical and R₃ is a C_{z} alkyl radical, n is 0 to 5, wherein x+n·y+z=18 to 24, and wherein the sum total of the weight percentage fractions, based on the total weight of the aqueous basecoat material, of all of the ether compounds of structural formula (I) is 0.1% to 5% by weight.

13. The method of claim 12, wherein the sum total of the weight percentage fractions, based on the total weight of the pigmented aqueous basecoat material, of all of the ether compounds of structural formula (I) is 0.2% to 4% by weight.

14. The method of claim 12, wherein a mixture of the said ether compounds is used.

15. The method of claim 12, wherein n is 0 and wherein x+n·y+z=18.
